(19) United States
(12) Patent Application Publication
(10) Pub. No.: US 2020/0146485 A1
(43) Pub. Date: May 14, 2020

(54) CONDENSATION RESISTANT COASTER

(71) Applicant: Anthony Vasquez, Midland, TX (US)

(72) Inventor: Anthony Vasquez, Midland, TX (US)

(21) Appl. No.: 16/185,222

(22) Filed: Nov. 9, 2018

(51) Int. Cl. A47G 23/03; A47G 23/032; B01J 20/10; B01J 20/04; B01J 20/28

(52) U.S. Cl. CPC A47G 23/03; A47G 23/032; B01J 20/28016; B01J 20/046; B01J 20/103

(57) ABSTRACT

A condensation resistant coaster, including a coaster main body including a top surface having substantially flat structure to allow a beverage container to be placed thereupon, and a plurality of crystals disposed on the top surface of the coaster main body to absorb moisture condensation from the beverage container.

### BACKGROUND

### 1. Field

The present general inventive concept relates generally to a coaster, and, particularly, to a condensation resistant coaster.

### 2. Description of the Related Art

Coasters are a common accessory for people enjoying drinks to protect the surface of furniture or other flat surface from condensation and/or liquid damage, or to support the beverage container.

Condensation may pose a particular problem, when water droplets form on the outside of a glass and down the outside surface of the container on to the coaster. Beverage drinkers tend to get frustrated when their cups or glasses stick to their coasters on a relaxed evening. Bottles and glasses tend to do this frequently, much to the dismay of their users and there are limited products available on the market that solves this issue.

Therefore, there is a need for a coaster that prevents adhesion to a beverage container due to condensation from the beverage container.

### SUMMARY

The present general inventive concept provides a condensation resistant coaster.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a condensation resistant coaster, including a coaster main body including a top surface having substantially flat structure to allow a beverage container to be placed thereupon, and a plurality of crystals disposed on the top surface of the coaster main body to absorb moisture condensation from the beverage container.

The condensation resistant coaster may further include a base disposed on a bottom surface of the coaster main body to provide friction between the condensation resistant coaster and a surface upon which the condensation resistant coaster is placed.

The plurality of crystals may include at least one of sand, fine grains, sea salt, table salt, mineral salt, crushed rock, powder, or a hygroscopic compound.

The plurality of crystals may be adhered to the top surface of the coaster main body.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a top view of a condensation resistant coaster, according to an exemplary embodiment of the present general inventive concept; and

FIG. 2 illustrates a side view of the condensation resistant coaster, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

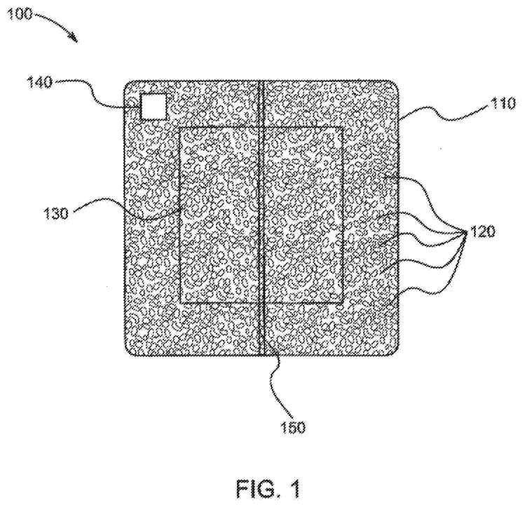

FIG. 1 illustrates a top view of a condensation resistant waster 100, according to an exemplary embodiment of the present general inventive concept.

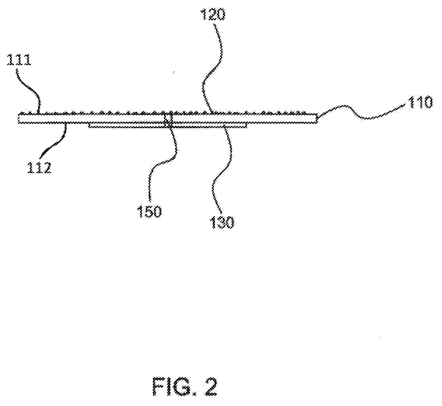

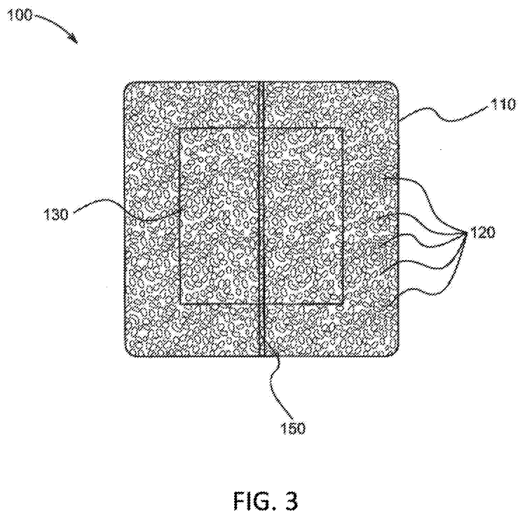

FIG. 2 illustrates a side view of the condensation resistant coaster 100, according to an exemplary embodiment of the present general inventive concept.

With respect to FIG. 1, the condensation resistant coaster 100 may include a coaster main body 110 and a plurality of crystals 120, but is not limited thereto.

The coaster main body 110 may include a top surface 111 having a substantially flat structure of any shape or any predetermined size based on a user's preferences, but may, typically, be of a handheld size. Although, the coaster main body 110 is illustrated in FIG. 1 to have a rectangular prism shape, the coaster main body 110 may be rectangular, circular, conical, spherical, or any feasible shape desired by a user.

The coaster main body 110 may be constructed from plastic, metal, wood, stone, paper, rubber, closed-cell extruded polystyrene foam, etc., but is not limited thereto. Additionally, an exterior of the coaster main body 110 may have predetermined assortment of colors or designs that may be selected by a user's preference.

The top surface 111 of the coaster main body 110 maybe substantially flat, and the coaster main body 110 may have a sufficient thickness (i.e., width) to allow beverage containers to be disposed thereon, while preventing a surface (e.g., table, countertop, coffee table, etc.) upon which the coaster 110 is placed from being damaged. In other words, the coaster main body 110 may have any thickness ranging from paper-thin to one inch thick.

The coaster main body 110 may include the plurality of crystals 120 widely dispersed on a least a portion of the top surface 111 of the coaster main body 110, but is not limited thereto. The plurality of crystals 120 may include at least one of (or combination of) sand, fine grains, sea salt, table salt, mineral salt, crushed rock, powder, or a hygroscopic compound.

The plurality of crystals 120 may be permanently affixed and/or adhered to surfaces of the coaster 110 (i.e., the top surface 111 or a bottom surface 112) via any known binding process and/or via any type of adhesive (e.g., glue, paste, etc.), thereby allowing the plurality of crystals 120 to remain attached to at least one surface of the coaster main body 110. As such, the coaster main body 110 may retain its absorbent properties and prevent moisture from accumulating on a bottom of a beverage container (e.g., a bottle, a glass, a can, etc., not illustrated), thereby also preventing the top surface 111 of the coaster main body 110 from sticking to the bottom of the beverage container.

The coaster main body 110 may include a base 130 to support it and prevent the coaster 110 from moving. The base 130 may be constructed from plastic, metal, wood, stone, rubber, latex, etc., but is not limited thereto. The base 130 may be disposed on the bottom surface 112 of the coaster main body 110 and may be positioned to contact any surface upon which the coaster main body 110 is placed. The base 130 may be substantially planar to the surface beneath it, and may be parallel to the bottom surface of the coaster main body 110, but is not limited thereto. The base 130 may have a rubber bottom to increase friction between the bottom surface 112 of the coaster main body 110 and the surface beneath it, thereby reducing the probability of movement by creating friction.

The coaster main body 110 may have a speaker 140 disposed on the top surface 111 of the coaster main body 110 at any feasible location, but is not limited thereto. The speaker 140 may have a processor, memory, and receiver to allow the user to wirelessly transmit music or stream any digital content the user desires. The speaker 140 may use BLUETOOTH, WIFI, cellular networks, etc., but is not limited thereto.

Referring to FIGS. 1 and 2, the coaster main body 110 may have at least one hinge 150 disposed on the bottom of the coaster main body 110. The at least one hinge 150 may allow the user to fold the coaster main body 110 to at least half of its size. The at least one hinge 150 may also be disposed on a diagonal and may be predetermined during construction of the coaster main body 110.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A condensation resistant coaster, comprising:
a coaster main body including a top surface having substantially flat structure to allow a beverage container to be placed thereupon; and
a plurality of crystals disposed on an entirety of the top surface and an entirety of a bottom surface of the coaster main body to absorb moisture condensation from the beverage container.

2. The condensation resistant coaster of claim 1, further comprising:
a base disposed on a bottom surface of the coaster main body to provide friction between the condensation resistant coaster and a surface upon which the condensation resistant coaster is placed.

3. The condensation resistant coaster of claim 1, wherein the plurality of crystals include at least one of sand, fine grains, sea salt, table salt, mineral salt, crushed rock, powder, or a hygroscopic compound.

4. The condensation resistant coaster of claim 1, wherein the plurality of crystals are adhered to the top surface of the coaster main body.

5. A condensation resistant coaster, comprising:
a coaster main body to receive a beverage container thereupon, such that the coaster main body folds to at least half its size;
a plurality of crystals disposed on a top surface and a bottom surface of the coaster main body to absorb moisture condensation from the beverage container, such that the plurality of crystals are constructed from mineral salt; and
a speaker disposed on at least a portion of the coaster main body to stream music therefrom.
